(19) United States
(12) Patent Application Publication
(10) Pub. No.: US 2005/0081649 A1
(43) Pub. Date: Apr. 21, 2005

(54) Vehicle weight meter

(75) Inventor: Naoya Takahashi, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: YAZAKI CORPORATION, Tokyo (JP)

(21) Appl. No.: 10/843,349

(22) Filed: May 12, 2004

(30) Foreign Application Priority Data
Oct. 15, 2003 (JP) 2003-354610

(51) Int. Cl. G01N 3/24

(52) U.S. Cl. 73/862.474

(57) ABSTRACT

To measure a load accurately by reducing effects of change of tire grounding points, a vehicle weight meter includes first and second strain detecting sensors for detecting strains of an axle shaft, a summing circuit for summing outputs of the first and second strain detecting sensors, and a computing circuit for calculating a load with a summed output of the summing circuit. The first strain detecting sensor is mounted on a side surface of the axle shaft between a load point and one end of the axle shaft. The second strain detecting sensor is mounted on the side surface of the axle shaft between the load point and the other end of the axle shaft.

### BACKGROUND OF THE INVENTION

1. Field of the Invention

This invention relates to a vehicle weight meter.

2. Description of the Related Art

An example of a structure according to a usual vehicle weight meter is described with reference to FIGS. 7 and 8. FIG. 7 is a schematic illustration of an area of an axle shaft of a vehicle on which the usual vehicle weight meter is mounted. FIG. 8 is a perspective view of the axle shaft.

In FIGS. 7 and 8, an inner tire 1 and an outer tire 2 structuring a double tire for a rear wheel of a vehicle such as a motor truck is mounted respectively on the both ends of the axle shaft 4 having a round hole 6 at the center thereof. In a middle area between the round hole 6 and the end of the axle shaft 4, a leaf-spring mounting portion 5a is provided. A leaf spring 5 is mounted on the top surface of the leaf-spring mounting portion 5a. A strain detect sensor 3 as a strain detecting means structuring the vehicle weight meter is mounted on each top surface of the axle shaft 4 between the ends of the axle shaft 4 and leaf-spring mounting portions 5a. The load weight of the vehicle (a load on a carrier) is supported through the leaf spring 5 by the axle shaft 4. The axle shaft 4 has a bending moment by the load weight. The strain detect sensor 3 detects the bending moment for measuring the load on the carrier.

In the vehicle weight meter detecting the bending moment on the axle shaft 4 by mounting the strain detect sensor 3 on the top surface thereof, when tire grounding points of the double tires of the rear wheels does not change, a measured value of the load has no measurement error because the bending moment is proportional to the load. Herein, the tire grounding point is defined by a point equivalent to the double tire with the inner tire 1 and the outer tire 2.

However, the tire grounding point is easily changed by road conditions or a change of tire air pressure, and the detected strain may be changed by a change of the bending moment even if the load is constant. Thereby, the measured value of the load has measurement error.

The measurement error in the measured value of the load will be described as following. A straight beam (corresponding to the axle shaft 4 in FIGS. 7 and 8) with a constant cross section along an axial direction under a uniform bending moment is discussed.

FIG. 9 shows bent straight beam under above condition, distribution of bending stress and distribution of shearing stress. A longitudinal strain ε generated at a position with a distance y from a neutral plane NN′, without expansion and contraction, of the straight beam 4 is defined by a following formula F1.
Å=(M/EI)y; F1

Herein, M is the bending moment, E is a modulus of longitudinal elasticity, and I is a geometrical moment of inertia. The longitudinal stress ε by bending is to be the maximum tensile strain ε1 at a bottom surface of the straight beam and to be the maximum compressive strain ε2 at a top surface of the straight beam.

In general, a bending moment and shearing stress act on a cross section of a beam when the beam has a transverse load. In FIG. 9, a bending moment acts between C and D in the beam, and shearing stress and bending moment act between A and C or D and B on the outer surface of the beam. The shearing stress τ is distributed to be the maximum value at the neutral plane and to be zero at the top end surface and the bottom end surface of the beam.

The strain detect sensors 3 shown in FIGS. 7 and 8 are generally mounted on the top surface of the axle shaft 4 for detecting compressive strain by a bending moment. The actual axle shaft 4 is formed to reduce the cross section from the leaf-spring mounting portion Sa toward the end portion thereof. The geometrical moment of inertia is smaller at an outer side (the end portion) from the leaf spring. Therefore, the strain thereof becomes larger against the same value of the bending moment. Thus, strain is easily detected at the outer side from the leaf spring near to the leaf spring mounting portion.

The load weight acts at a position of the leaf-spring mounting portion 5a as a point of action on the axle shaft 4. The bending moment against the load weight is generated and a reaction force is generated at the tire grounding point. This condition can be considered as a condition that concentrated loads W_{A}, W_{B} by the load weight act on points of action of a simply supported beam (corresponding to the axle shaft 4). Condition of forces applied on the simply supported beam is shown in FIGS. 10A, 10B.

In FIG. 10A, reaction forces R_{A}, R_{B} generated at the tire grounding points are defined by following formulas F2, F3.
R_{A}={W_{A}(b+c)+W_{B}b}/(a+b+c); F2
R_{B}={W_{A}a+W_{B}(a+c)}/(a+b+c); F3

Herein, a is a distance from the tire grounding point A at one end of the simply supported beam to the point of action C, b is a distance from the tire grounding point B at the other end of the simply supported beam to the point of action D, and c is a distance between C and D.

Defining x as an any distance from the point of action C toward the point of action D, the relation between the shearing force F, reaction force R at grounding point and bending moment is shown as following formulas.

Area between A and C (−a≦x≦0)
F=R_{A}; F4
M=R_{A}(x+a); F5

Area between C and D (0≦x≦c)
F=R_{A}−W_{B}; F6
M=R_{A}(x+a)+W_{A}·x=R_{A}·a+(R_{A}+W_{A})x; F7

Area between D and B (c≦x≦b+c)
F=R_{A}−W_{A}−W_{B}=−R_{B}; F8
M=R_{B}(b+c−x); F9

When the load weight act as equally-divided loads on the beam, the reaction forces and bending moments at grounding points are shown as following formulas by defining W_{A}=W_{B}=W.
R_{A}=W(2b+c)/(a+b+c); F10
R_{B}=W(2a+c)/(a+b+c); F11
M_{A}=Wa(2b+c)/(a+b+c); F12
M_{B}=Wb(2a+c)/(a+b+c); F13

The tire grounding point is easily changed by bumps or a slant of a load, or by condition of air pressure of tires. On the assumption that the grounding points A and B are changed to A′ (>A) and B′ (>B), the reaction force at the grounding point and the bending moment are affected thereby, as shown in FIG. 10B.

When distances a, b change respectively to distance a′=a+Δa and b′=b+Δb, an amount of change of a bending moment ΔM is calculated as follows.

$$\begin{matrix}\begin{matrix}Δ {M}_{A} = ( \partial {M}_{A} / \partial a ) Δ a + ( \partial {M}_{A} / \partial b ) Δ b \\ = W \{ ( b + c ) ( 2 b + c ) Δ a + a ( 2 a + c ) Δ b \} / {( a + b + c )}^{2} ;\end{matrix} & F14 \\ \begin{matrix}Δ {M}_{B} = ( \partial {M}_{B} / \partial a ) Δ a + ( \partial {M}_{B} / \partial b ) Δ b \\ = W \{ b ( 2 b + c ) Δ a + ( a + c ) ( 2 a + c ) Δ b \} / {( a + b + c )}^{2} ;\end{matrix} \\ Δ {M}_{A} + Δ {M}_{B} = W \{ {( 2 b + c )}^{2} Δ a + {( 2 a + c )}^{2} Δ b \} / {( a + b + c )}^{2} ; & F15\end{matrix}$$

ΔM_{A}+ΔM_{B}=W{(2b+c)²Δa+(2a+c)²Δb}/(a+b+c)²; F16

According to the above formulas F14, F15, F16, when the load weight is calculated with detected outputs of compressive strains by bending moments detected at one or two points of the strain detect sensors 3 on the axle shaft 4, it is understandable that an error of result by change of tire grounding point cannot be avoided.

To overcome the above drawback, one object of this invention is to provide a vehicle weight meter which can measure a load weight accurately by reducing the effect of change of tire grounding points.

### SUMMARY OF THE INVENTION

In order to attain the objects, a vehicle weight meter according to this invention includes a first strain detecting means for detecting strain of an axle shaft, a second strain detecting means for detecting strain of said axle shaft, a summing means for summing outputs of the first and second strain detecting means and computing means for calculating a load weight with a summed output of the summing means. The strain of the axle shaft is caused by a shearing force applied on the axle shaft. The first strain detecting means is mounted on a side surface of the axle shaft between a load point and one end of the axle shaft of the vehicle. The second strain detecting means is mounted on the side surface of said axle shaft between the load point and the other end of said axle shaft of the vehicle.

According to the aforesaid vehicle weight meter, the load weight can be measured accurately by reducing errors by change of tire grounding points.

The first and second strain detecting means are preferably mounted on a neutral plane of bending moment on the side surface of the axle shaft.

According to the aforesaid vehicle weight meter, the load weight can be measured accurately without effects of bending moments.

The first and second strain detecting means are preferably mounted to be tilted with a predetermined angle against a direction of an axis of the axle shaft.

According to the aforesaid vehicle weight meter, the load weight can be measured accurately by detecting compressive strains by shearing forces.

The predetermined angle is preferably 45 degrees.

According to the aforesaid vehicle weight meter, the load weight can be measured accurately by sensitively detecting compressive strains by shearing forces

The above and other objects and features of this invention will become more apparent from the following description taken in conjunction with the accompanying drawings.

### BRIEF DESCRIPTION OF THE DRAWINGS

FIG. 1 is a schematic illustration about an area of an axle shaft of a vehicle on which a vehicle weight meter according to this invention is installed;

FIG. 2 is a perspective view of the axle shaft in FIG. 1;

FIG. 3 is a partially expanded view of FIG. 1;

FIG. 4 is an exploded perspective view, showing an example structure of the strain detect sensor in FIG. 1;

FIG. 5 is a schematic illustration for explaining an action of a shearing force;

FIG. 6 is a circuit diagram of the vehicle weight meter according to this invention;

FIG. 7 is a schematic illustration about an area of an axle shaft of a vehicle on which a usual vehicle weight meter is installed;

FIG. 8 is a perspective view of the axle shaft in FIG. 7;

FIG. 9 is a schematic illustration for showing a bent straight beam, distribution of bending stress and distribution of shearing stress;

FIG. 10A is a schematic illustration for explaining relation between forces applied on a cantilever;

FIG. 10B is a schematic illustration for explaining relation between forces applied on a cantilever at changed grounding points; and

Table 1 shows ratios of errors corresponding to respective conditions of changes of tire grounding points.

### DESCRIPTION OF THE PREFERRED EMBODIMENT

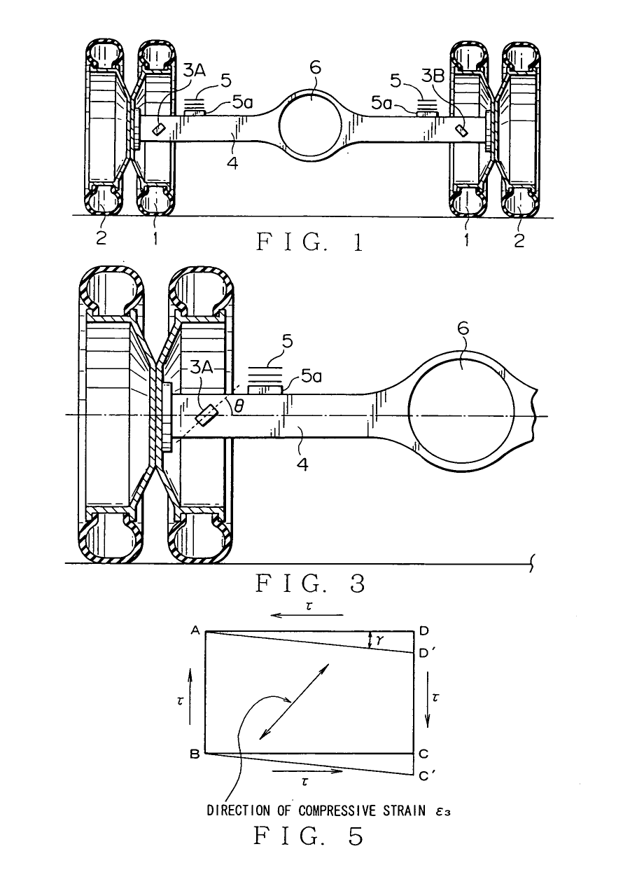

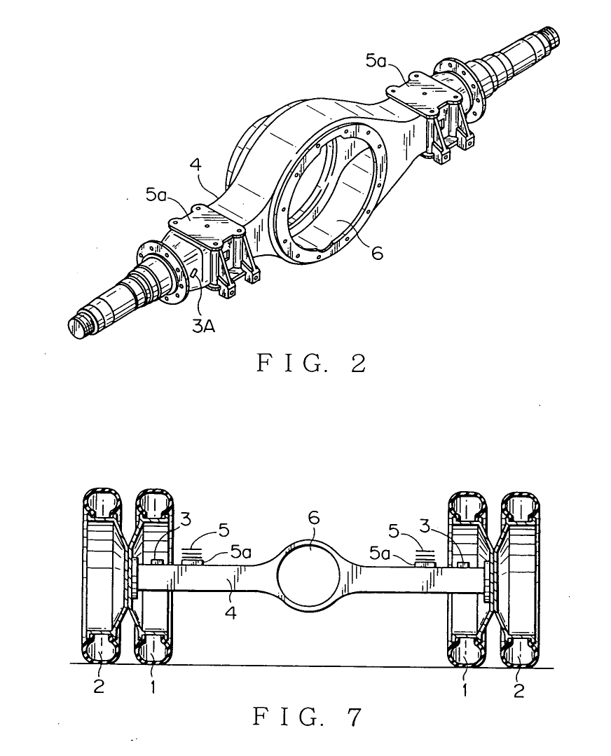

An embodiment according to this invention is explained as following with reference of drawings. FIG. 1 is a schematic illustration about an area of an axle shaft of a vehicle on which a vehicle weight meter according to this invention is installed. FIG. 2 is a perspective view of the axle shaft.

In FIGS. 1 and 2, an inner tire 1 and an outer tire 2 structuring a double tire for a rear wheel of a vehicle such as a motor truck are mounted respectively on the both ends of the axle shaft 4 having a round hole 6 at the center thereof. In middle areas between the round hole 6 and the both ends of the axle shaft 4, a leaf-spring mounting portion 5a is respectively provided. A leaf spring 5 is mounted on the top surface of the leaf-spring mounting portion 5a. The load weight of the vehicle (a load on a carrier) is supported through the leaf spring 5 by the axle shaft 4.

Strain detect sensors 3A, 3B serving as strain detecting means structuring the vehicle weight meter according to this invention are mounted respectively on each side surface of the axle shaft 4 between one end of the axle shaft 4 and leaf-spring mounting portions 5a and between the other end of the axle shaft 4 and leaf-spring mounting portions Sa. Two strain detect sensors 3A, 3B are mounted at respective positions with the same distance from the round hole 6 of the axle shaft 4 toward each end, in other words, at respective positions symmetric with respect to the center of the round hole 6.

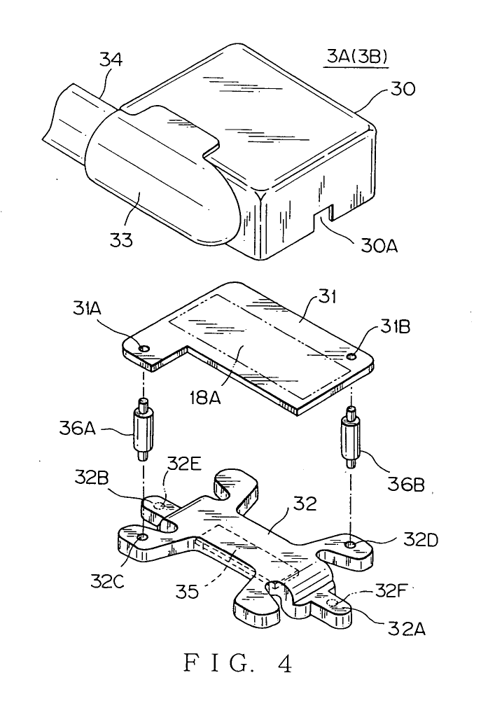

FIG. 3 is a partially expanded view of FIG. 1. The strain detect sensor 3A is mounted on a neutral plane of bending moment on a side surface of the axle shaft 4 with a tilt of the predetermined angle θ against an axis (horizontal line) of the axle shaft 4, as shown in FIG. 3. The predetermined angle θ may be any angle, and is preferable 45 degrees in FIG. 3. The strain detect sensor 3B is also preferably mounted with a tilt of 45 degrees. FIG. 4 is an exploded perspective view showing an example structure of the strain detect sensors 3A, 3B. An example structure of the strain detect sensor 3A, 3B is disclosed in the document of the Japan Patent 2002-71437. The strain sensor 3 has a case 30 forming a rectangular-solid-like outer shell, a circuit board 30, a base assembly 31 and supporting members 36A, 36B.

A sensing element 35 for detecting strain is mounted on the base assembly 32. The sensing element 35 is structured by forming a metal foil strain gauge on a substrate made long thin-plate-like of a metal such as a stainless steel. The sensing element 35 detects strain by utilizing the principle that the resistance of the metal foil strain gauge is changed correspondingly to a load on the metal substrate. The load on the substrate is transmitted accordingly to a deformation of a mounting member on which fixing tabs 32A, 32B formed integrally and extending from ends of the base assembly 32 are welded and fixed. The base assembly 32 has two holes 32C, 32D. Ends of the supporting members 36A, 36B are inserted into the holes 32C, 32D, and the base assembly 32 is connected with the circuit board 31.

Ends of the supporting members 36A, 36B are inserted into holes 31A, 31B provided in the circuit board 31 into which the ends of the supporting members 36A, 36B will be inserted. An amplifier 18A for amplifying detected output from the sensing element 35 is mounted on the circuit board 31.

The case 30 is mounted so as to cover the circuit board 31 and the base assembly 32 connected as mentioned above. When the case 30 is mounted, the fixing tab 32A of the base assembly 32 is inserted into a concave cutout 30A formed on an edge of opening at a side wall of the case 30, and the fixing tab 32B is inserted into a concave cutout (not shown) formed on an edge of the opening at an opposite side wall of the case 30. A lead wire 34 for transmitting a signal of detecting a weight is electrically connected through a fixing metal bracket 33 with the case 30.

The strain detect sensors 3A, 3B structured as shown in FIG. 4 are mounted so as to be disposed in respective lengthwise directions of the sensing elements 35 to tilt 45 degrees against the axis of the axle shaft 4 shown in FIG. 3.

The strain detect sensors 3A, 3B are mounted as mentioned above, so that a strain caused by a shearing force acting on the axle shaft 4 by a load can be sensitively detected.

In a rectangular portion with apexes A, B, C, D as a part of the axle shaft 4 when seeing from side, when a side AB (corresponding to the tire grounding point) is fixed and a side CD (corresponding to a point of action) is loaded, it is considerable that the side CD of a cantilever supported at the side AB is acted by a shearing force, as shown in FIG. 5.

A shearing stress τ is generated in an inner cross section of the axle shaft 4 by the shearing force, and the rectangular portion ABCD is deformed into a parallelogram portion ABC′D′. A tilt of the parallelogram portion ABC′D′ against the rectangular portion ABCD by shearing deformation is a shearing strain γ.

A compressive strain ε3 caused by the shearing force is generated in a direction of 45 degrees against the side AD or BC. Because the strain detect sensors 3A, 3B are mounted as mentioned above so as to be disposed in respective lengthwise directions of the sensing elements 35 to tilt 45 degrees against the axis of the axle shaft 4 shown in FIG. 3, the compressive strain ε3 caused by the shearing force can be detected.

When the distances a, b are changed respectively to the distances a′=a+Δa, b′=b+Δb as shown in FIGS. 10A, 10B, an amount of change ΔR of a reaction force at the grounding point is calculated as follows.

$$\begin{matrix}\begin{matrix}Δ {R}_{A} = ( \partial {R}_{A} / \partial a ) Δ a + ( \partial {R}_{A} / \partial b ) Δ b \\ = W \{ - ( 2 b + c ) Δ a + ( 2 a + c ) Δ b \} / {( a + B + C )}^{2}\end{matrix} & F17 \\ \begin{matrix}Δ {R}_{B} = ( \partial {R}_{B} / \partial a ) Δ a + ( \partial {R}_{B} / \partial b ) Δ b \\ = W \{ ( 2 b + c ) Δ a - ( 2 a + c ) Δ b \} / {( a + B + C )}^{2}\end{matrix} & F18 \\ Δ {R}_{A} + Δ {R}_{B} = 0 & F19\end{matrix}$$

ΔR_{A}+ΔR_{B}=0 F19

When the load weight is calculated with the detected output of the compressive strain caused by the shearing force at one point on the side of the axle shaft 4 by means of the strain detect sensor 3, it is understood under the relation between above formulas F16, F17 and F4, F8 that error caused by a change of the tire grounding point cannot be avoided, as mentioned above in the related art.

If the detected outputs of the compressive strains caused by the shearing forces detected by means of the strain detect sensors 3A, 3B mounted respectively between one end of the axle shaft 4 and one leaf-spring mounting portion 5a, and between the other end of the axle shaft 4 and the other leaf-spring mounting portion 5a on the side of the axle shaft 4 are summed, amounts of changes of reaction forces by change of the tire grounding points are cancelled under the relation between above formulas F19 and F4, F8, so that the amount of change of the shearing force is cancelled.

Thus, the error by change of tire grounding point is avoided by calculating the load weight, i.e., load on a carrier, with an summed signal by summing the detect outputs of the strain detect sensors 3A, 3B.

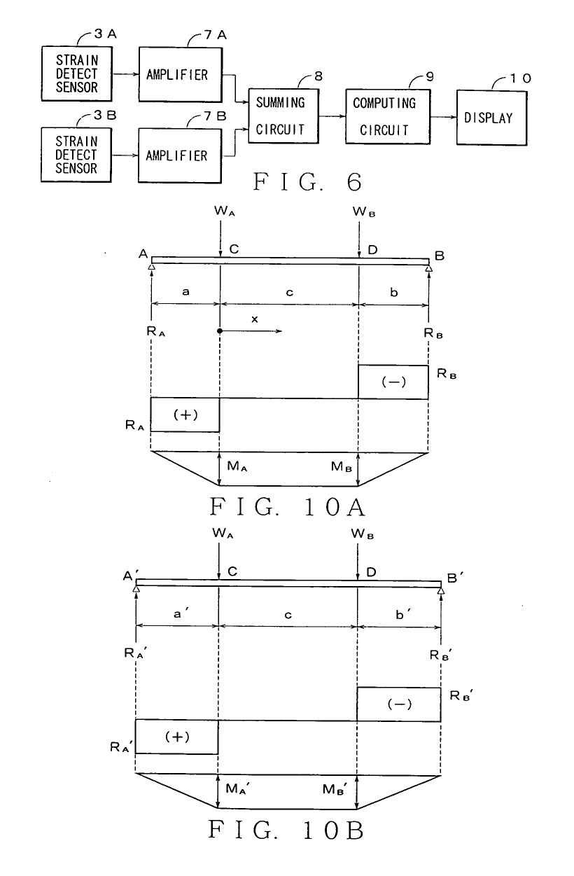

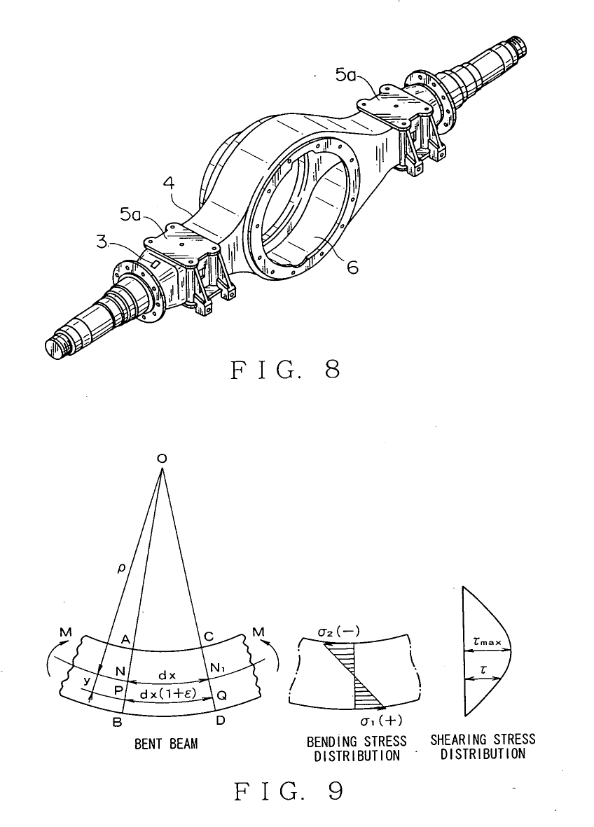

According to a circuit shown in FIG. 6, the detected outputs of two strain detect sensors 3A, 3B are amplified by respective amplifiers 7A, 7B. Thereafter, the outputs are summed at a summing circuit 8 as a summing means, and the summed output signal is supplied to a computing circuit 9 as a computing means. The computing circuit 9 computes the load weight (a load on the carrier) with the summed output signal from the summing circuit 8. The load weight computed by the computing circuit 9 is displayed in a display 10.

The embodiment according to the invention is described above. It will be apparent to one of ordinary skill in the art that many changes and modifications can be made thereto without departing from the scope of the invention.

As the aforesaid best structure for mounting, the strain detect sensors 3A, 3b are mounted on a neutral plane of bending moment on a side surface of the axle shaft 4 with a tilt angle of 45 degrees against an axis (horizontal line) of the axle shaft 4. The strain detect sensors 3A, 3B can be mounted on any place other than a neutral plane of bending moment on a side surface. The strain detect sensors 3A, 3B can be also mounted with a tilt other than 45 degrees (excluding zero and 90 degrees).

According to the above embodiment, the load on a carrier is measured with the summed signal of detected outputs of the strain detect sensors 3A, 3B by the shearing force on the axle shaft for rear double tires. Providing a strain detect sensor (not shown) on a front axle shaft, and supplying detected output of the strain detect sensor to the computing circuit 9, an own weight of the vehicle and/or the load weight can also be measured. A single tire is mounted on the front axle shaft so that change of tire grounding point is small. Therefore, it is not required for the front axle shaft to detect the strain by shearing force according to this invention, and detecting compressive strain by bending moment can be applied.

The computing circuit 9 can be structured with a microcomputer. Storing a vehicle weight previously in an inner memory of the microcomputer, a total weight of the vehicle can be computed and displayed as a vehicle weight meter.

To compare a vehicle weight meter according to this invention and a usual vehicle weight meter, errors are calculated to input physically numerical value in above formulas. Setting a=b=300 mm, c=1010 mm, for each conditions of Δa=15 mm, Δb=15 mm, and Δa=15 mm, Δb=0 mm, and Δa=15 mm, Δb=−15 mm, ratios of errors ΔR_{A}/R_{A}, ΔR_{B}/R_{B}, ΔR_{A}+ΔR_{B}/R_{A}+R_{B}, ΔM_{A}/M_{A}, ΔM_{B}/M_{B}, ΔM_{A}+ΔM_{B}/M_{A}+M_{B} are calculated and shown in Table 1.

Table 1 shows ratios of errors corresponding to respective conditions of changes of tire grounding points.

Table 1 shows followings:

When both of right and left tire grounding points are changed outward, the bending moment is most effected.

When only one of right and left tire grounding points is changed outward, the bending moment is effected half compared with above.

When a distance between right and left tire grounding points is not changed, for example, when the vehicle is resting on a right-left slant road, error is cancelled if the vehicle weight is calculated by the sum of the right and left bending moment.

When the load weight is calculated with a summed value of reaction forces at the grounding points, no error occurs even if the tire grounding points are changed.

Having now fully described the invention, it will be apparent to one of ordinary skill in the art that many changes and modifications can be made thereto without departing from the scope of the invention as set forth herein.

TABLE 1

| CHANGE OF TIRE GROUNDING POINTS | $\frac{{ΔR}_{A}}{{R}_{A}}$ | $\frac{{ΔR}_{B}}{{R}_{B}}$ | $\frac{{ΔR}_{A} + {ΔR}_{B}}{{R}_{A} + {R}_{B}}$ | $\frac{{ΔM}_{A}}{{M}_{A}}$ | $\frac{{ΔM}_{B}}{{M}_{B}}$ | $\frac{{ΔM}_{A} + {ΔM}_{B}}{{M}_{A} + {M}_{B}}$ |
|---|---|---|---|---|---|---|
| Δa = 15 mm, Δb = 15 mm | 0% | 0% | 0% | +5% | +5% | +5% |
| Δa = 15 mm, Δb = 0 | 0.93% | +0.93% | 0% | +4.1% | +0.93% | +2.5% |
| Δa = 15 mm, Δb = 15 mm | 1.9% | +1.9% | 0% | +3.1% | −3.1% | 0% |

1. A vehicle weight meter comprising:
first strain detecting means for detecting strain of an axle shaft caused by shearing force applied on said axle shaft, said first strain detecting means being mounted on a side surface of said axle shaft between a load point and one end of said axle shaft of a vehicle;
second strain detecting means for detecting strain of said axle shaft caused by shearing force applied on said axle shaft, said second strain detecting means being mounted on the side surface of said axle shaft between the load point and the other end of said axle shaft of the vehicle;
summing means for summing outputs of the first and second strain detecting means; and
computing means for calculating a load weight with a summed output of said summing means.

2. The vehicle weight meter according to claim 1, wherein said first and second strain detecting means are mounted on a neutral plane of bending moment on the side surface of said axle shaft.

3. The vehicle weight meter according to claim 1, wherein said first and second strain detecting means are mounted to be tilted with a predetermined angle against a direction of an axis of said axle shaft.

4. The vehicle weight meter according to claim 3, wherein said predetermined angle is 45 degrees.

5. The vehicle weight meter according to claim 2, wherein said first and second strain detecting means are mounted to be tilted with a predetermined angle against a direction of an axis of said axle shaft.
